(19) United States
(12) Patent Application Publication
(10) Pub. No.: US 2020/0032490 A1
(43) Pub. Date: Jan. 30, 2020

(54) FILLING EARTH AT A LOCATION WITHIN A DIG SITE USING AN EXCAVATION VEHICLE

(71) Applicant: Built Robotics Inc., San Francisco, CA (US)

(72) Inventors: Noah Austen Ready-Campbell, San Francisco, CA (US); Gaurav Jitendra Kikani, San Francisco, CA (US); Lucas Bruder, San Francisco, CA (US); Andrew Liang, San Francisco, CA (US); Cyrus Ready-Campbell, San Francisco, CA (US); Pradeesh Suganthan, Mountain View, CA (US); James Alan Emerick, Berkeley, CA (US)

(21) Appl. No.: 16/447,970

(22) Filed: Jun. 21, 2019

Related U.S. Application Data
(60) Provisional application No. 62/703,767, filed on Jul. 26, 2018.

(51) Int. Cl. E02F 9/26; E02F 9/20; G05D 1/00; E02D 3/02

(52) U.S. Cl. CPC E02F 9/262; E02F 9/205; E02F 9/2041; G05D 2201/0202; E02F 9/265; E02D 3/02; G05D 1/0088

(57) ABSTRACT

This description provides an autonomous or semi-autonomous excavation vehicle that is capable of navigating through a dig site and carrying an excavation routine using a system of sensors physically mounted to the excavation vehicle. The sensors collect one or more of spatial, imaging, measurement, and location data representing the status of the excavation vehicle and its surrounding environment. Based on the collected data, the excavation vehicle executes instructions to carry out an excavation routine by filling earth into a hole within the site and compacting the earth. The excavation vehicle is also able to carry out numerous other tasks, such as checking the volume of excavated earth in an excavation tool, and helping prepare a digital terrain model of the site as part of a process for creating the excavation routine.

### BACKGROUND

### Field of Art

The disclosure relates generally to method for excavating earth from a dig site, and more specifically to excavating earth using a vehicle operated by a sensor assembly configured to control the vehicle.

### Description of the Related Art

Vehicles such as backhoes, loaders, and excavators, generally categorized as excavation vehicles, are used to excavate earth from locations. Currently, operation of these excavation vehicles is very expensive as each vehicle requires a manual operator be available and present during the entire excavation. Further complicating the field, there is an insufficient labor force skilled enough to meet the demand for operating these vehicles. Because these vehicles must be operated manually, excavation can only be performed during the day, extending the duration of excavation projects and further increasing overall costs. The dependence of current excavation vehicles on manual operators increases the risk of human error during excavations and reduce the quality of work done at the site.

### SUMMARY

Described is an autonomous or semi-autonomous excavation system that unifies an excavation vehicle with a sensor system for excavating earth from a site. The excavation system controls and navigates an excavation vehicle through an excavation routine of a site. The excavation system uses a combination of sensors integrated into the excavation vehicle to record the positions and orientations of the various components of the excavation vehicle and/or the conditions of the surrounding earth. Data recorded by the sensors may be aggregated or processed in various ways, for example, to determine and control the actuation of the vehicle's controls, to generate representations of the current state of the site, to perform measurements and generate analyses based on those measurements, and perform other tasks described herein.

According to an embodiment, a method for filling earth at a site includes accessing an elevation map from the memory of a computer communicatively coupled to the excavation vehicle. An elevation map describes a target elevation for earth at a plurality of locations within the site. The communicatively coupled computer executes a set of instructions for the excavation vehicle to perform. The excavation vehicle retrieves earth from a first of the locations within the site with a tool physically coupled to the excavation vehicle. The excavation vehicle navigates the tool to a second location of the plurality. The second location is a physically measurable distance away from the first location. The excavation vehicle positions a leading edge of the tool above a surface of the second location, releases earth from the tool onto the surface of the second location, and records an updated elevation of earth at the second location using a sensor mounted on the excavation vehicle.

The described excavation system reduces the cost of excavating a site by reducing the need for manual labor, by obtaining actionable information that helps design and increase the efficiency of the excavation project, and by improving the overall quality and precision of the project by carrying out consistent, repeatable actions in accordance with excavation plans.

### BRIEF DESCRIPTION OF DRAWINGS

FIG. 1 shows an excavation system for excavating earth, according to an embodiment.

FIG. 2A illustrates the example placement of sensors for a compact track loader, according to an embodiment.

FIG. 2B illustrates the example placement of sensors for an excavator, according to an embodiment.

FIG. 3 is a high-level block diagram illustrating an example of a computing device used in an on-unit computer, off-unit computer, and/or database server, according to an embodiment.

FIG. 4 is a diagram of the system architecture for controlling an excavation vehicle, according to an embodiment.

FIG. 5 is a diagram of the system architecture for the preparation module, according to an embodiment.

FIG. 6 is a diagram of the system architecture for the earth removal module, according to an embodiment.

FIG. 7 illustrates an example coordinate space in which an excavation vehicle carries out a fill routine in a dig site, according to an embodiment.

FIG. 8A is a diagram of the system architecture for the refinement module, according to an embodiment.

FIG. 8B is a flowchart describing the process by which the refinement module 440 fills sinks within the site and compacts the filled earth, according to an embodiment.

The figures depict various embodiments of the presented invention for purposes of illustration only. One skilled in the art will readily recognize from the following discussion that alternative embodiments of the structures and methods illustrated herein may be employed without departing from the principles described herein.

### DETAILED DESCRIPTION

### I. Excavation System

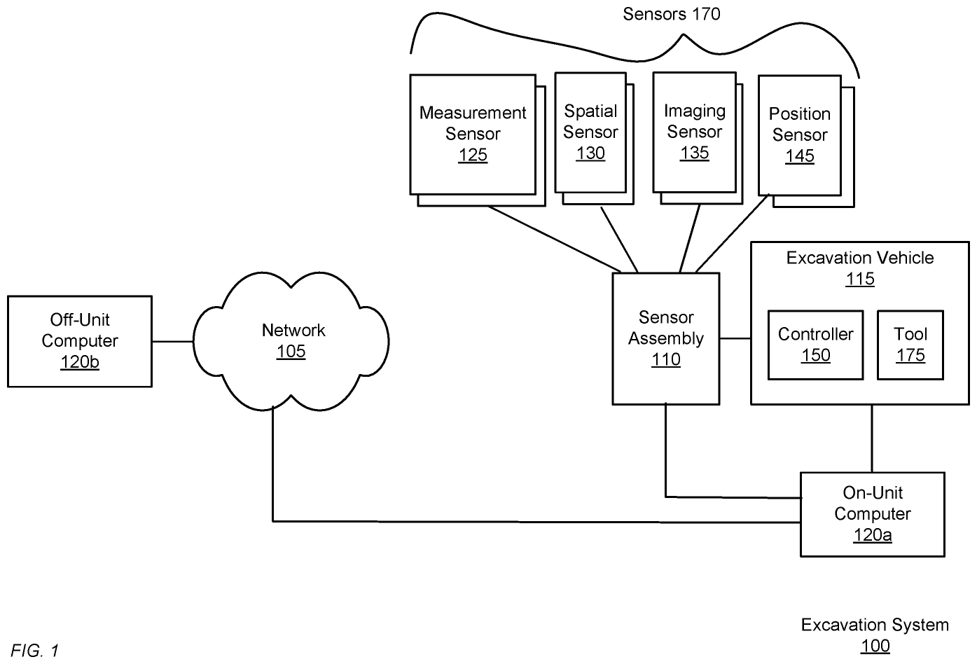

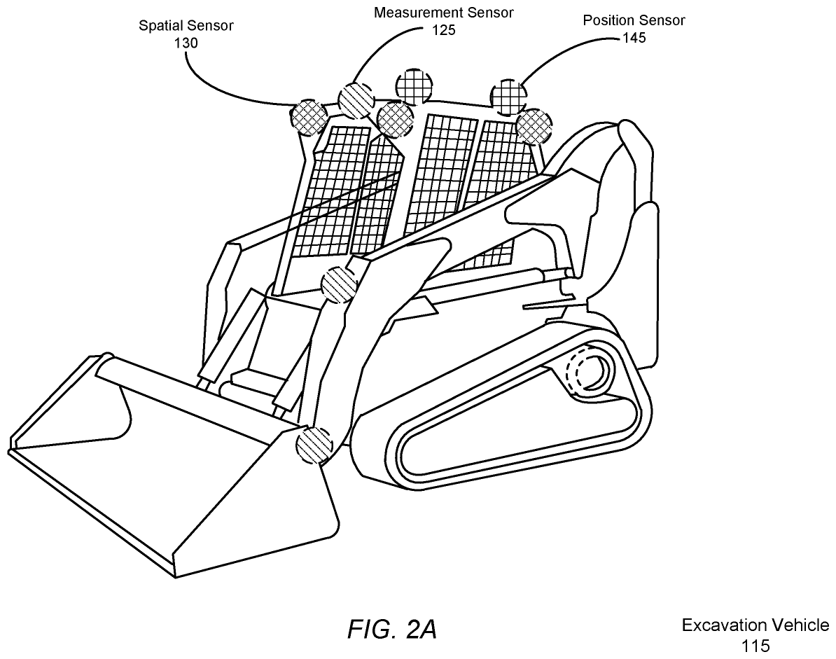

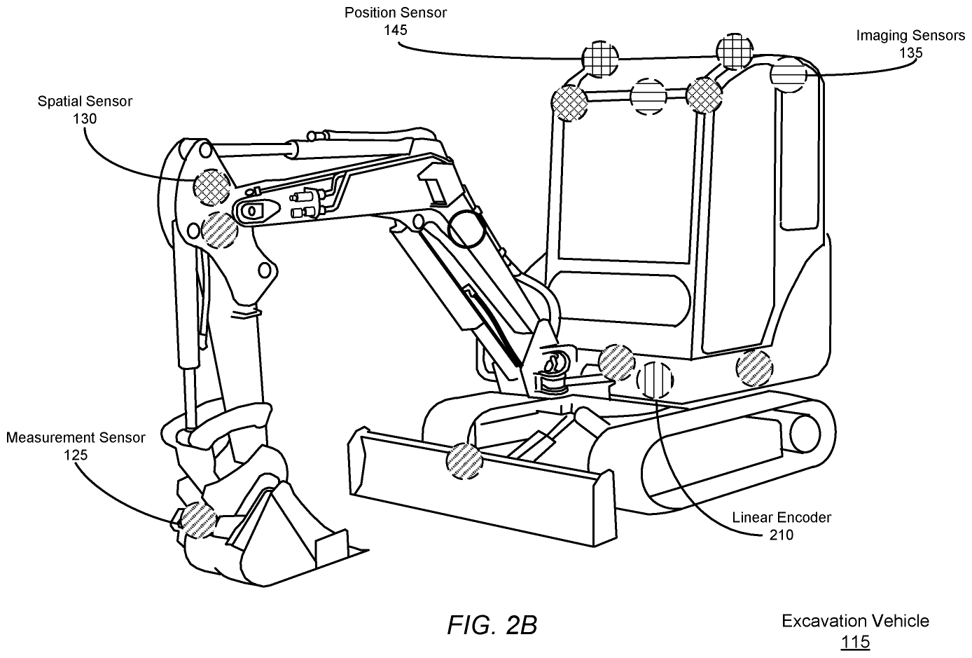

FIG. 1 shows an excavation system 100 for excavating earth autonomously or semi-autonomously from a dig site using a suite of one or more sensors 170 mounted on an excavation vehicle 115 to record data describing the state of the excavation vehicle 115 and the excavated site. As examples, FIGS. 2A and 2B illustrate the example placement of sensors for a compact track loader and an excavator, respectively, according to example embodiments. FIGS. 1-2B are discussed together in the following section for clarity.

The excavation system 100 includes a set of components physically coupled to the excavation vehicle 115. These include a sensor assembly 110, the excavation vehicle 115 itself, a digital or analog electrical controller 150, and an on-unit computer 120a. The sensor assembly 110 includes one or more of any of the following types of sensors: measurement sensors 125, spatial sensors 130, imaging sensors 135, and position sensors 145.

Each of these components will be discussed further below in the remaining sub-sections of FIG. 1. Although FIG. 1 illustrates only a single instance of most of the components of the excavation system 100, in practice more than one of each component may be present, and additional or fewer components may be used different than those described herein.

I.A. Excavation Vehicle

The excavation vehicle 115 is an item of heavy equipment designed to excavate earth from a hole within a dig site. Excavation vehicles 115 are typically large and capable of moving large volumes of earth at a single time, particularly relative to what an individual human can move by hand. Generally, excavation vehicles 115 excavate earth by scraping or digging earth from beneath the ground surface. Examples of excavation vehicles 115 within the scope of this description include, but are not limited to loaders such as backhoe loaders, track loaders, wheel loaders, skid steer loaders, scrapers, graders, bulldozers, compactors, excavators, mini-excavators, trenchers, skip loaders.

Among other components, excavation vehicles 115 generally include a chassis 205, a drive system 210, an excavation tool 175, an engine (not shown), an on-board sensor assembly 110, and a controller 150. The chassis 205 is the frame upon on which all other components are physically mounted. The drive system 210 gives the excavation vehicle 115 mobility through the excavation site. The excavation tool 175 includes not only the instrument collecting dirt, such as a bucket or shovel, but also any articulated elements for positioning the instrument for the collection, measurement, and dumping of dirt. For example, in an excavator or loader the excavation tool refers not only to the bucket but also the multi-element arm that adjusts the position and orientation of the tool.

The engine powers both the drive system 210 and the excavation tool 175. The engine may be an internal combustion engine, or an alternative power source such as an electric motor or battery. In many excavation vehicles 115, the engine powers the drive system 210 and the excavation tool commonly through a single hydraulic system, however other means of actuation may also be used. A common property of hydraulic systems used within excavation vehicles 115 is that the hydraulic capacity of the vehicle 115 is shared between the drive system 210 and the excavation tool. In some embodiments, the instructions and control logic for the excavation vehicle 115 to operate autonomously and semi-autonomously includes instructions relating to determinations about how and under what circumstances to allocate the hydraulic capacity of the hydraulic system.

I.B. Sensor Assembly

As introduced above, the sensor assembly 110 includes a combination of one or more of: measurement sensors 125, spatial sensors 130, imaging sensors 135, and position sensors 145. The sensor assembly 110 is configured to collect data related to the excavation vehicle 115 and environmental data surrounding the excavation vehicle 115. The controller 150 is configured to receive the data from the assembly 110 and carry out the instructions of the excavation routine provided by the computers 120 based on the recorded data. This includes control the drive system 210 to move the position of the tool based on the environmental data, a location of the excavation vehicle 115, and the excavation routine.

Sensors 170 are either removably mounted to the excavation vehicle 115 without impeding the operation of the excavation vehicle 115, or the sensor is an integrated component that is a native part of the excavation vehicle 115 as made available by its manufacturer. Each sensor transmits the data in real-time or as soon as a network connection is achieved, automatically without input from the excavation vehicle 115 or a human operator. Data recorded by the sensors 170 is used by the controller 150 and/or on-unit computer 120a for analysis of, generation of and carrying out of excavation routines, among other tasks.

Position sensors 145 provide a position of the excavation vehicle 115. This may be a localized position within a dig site, or a global position with respect to latitude/longitude, or some other external reference system. In one embodiment, a position sensor is a global positioning system interfacing with a static local ground-based GPS node mounted to the excavation vehicle 115 to output a position of the excavation vehicle 115.

Spatial sensors 130 output a three-dimensional map in the form of a three-dimensional point cloud representing distances, for example between one meter and fifty meters, between the spatial sensors 130 and the ground surface or any objects within the field of view of the spatial sensor 130, in some cases per rotation of the spatial sensor 130. In one embodiment, spatial sensors 130 include a set of light emitters (e.g., Infrared (IR)) configured to project structured light into a field near the excavation vehicle 115, a set of detectors (e.g., IR cameras), and a processor configured to transform data received by the infrared detectors into a point cloud representation of the three-dimensional volume captured by the detectors as measured by structured light reflected by the environment. In one embodiment, the spatial sensor 130 is a LIDAR sensor having a scan cycle that sweeps through an angular range capturing some or all of the volume of space surrounding the excavation vehicle 115. Other types of spatial sensors 130 may be used, including time-of-flight sensors, ultrasonic sensors, and radar sensors.

Imaging sensors 135 capture still or moving-video representations of the ground surface, objects, and environment surrounding the excavation vehicle 115. Examples imaging sensors 135 include, but are not limited to, stereo RGB cameras, structure from motion cameras, and monocular RGB cameras. In one embodiment, each camera can output a video feed containing a sequence of digital photographic images at a rate of 20 Hz. In one embodiment, multiple imaging sensors 135 are mounted such that each imaging sensor captures some portion of the entire 360 degree angular range around the vehicle. For example, front, rear, left lateral, and right lateral imaging sensors may be mounted to capture the entire angular range around the excavation vehicle 115.

Measurement sensors 125 generally measure properties of the ambient environment, or properties of the excavation vehicle 115 itself. These properties may include tool position/orientation, relative articulation of the various joints of the arm supporting the tool, vehicle 115 speed, ambient temperature, hydraulic pressure (either relative to capacity or absolute) including how much hydraulic capacity is being used by the drive system 210 and the excavation tool separately. A variety of possible measurement sensors 125 may be used, including hydraulic pressure sensors, linear encoders, radial encoders, inertial measurement unit sensors, incline sensors, accelerometers, strain gauges, gyroscopes, and string encoders.

There are a number of different ways for the sensor assembly 110, generally, and the individual sensors, specifically, to be constructed and/or mounted to the excavation vehicle 115. This will also depend in part on the construction of the excavation vehicle 115. Using the compact track loader of FIG. 2A as an example, the representations with diagonal crosshatching represent the example placements of a set of measurement sensors 125, the representation with diamond crosshatching represent example placements of a set of spatial sensors 130, and the representations with grid crosshatching represent example placements of a set of position sensors 145. Using the excavator of FIG. 2B as another example, diagonal crosshatchings represent measurement sensors 125, diamond crosshatchings represent spatial sensors 130, and grid crosshatchings represent position sensors 145. Additionally, vertical crosshatchings near the drive system 210 represent example placements for a linear encoder 210 and horizontal crosshatchings near the roof represent imaging sensors 135, for example RGB cameras.

Generally, individual sensors as well as the sensor assembly 110 itself range in complexity from simplistic measurement devices that output analog or electrical systems electrically coupled to a network bus or other communicative network, to more complicated devices which include their own onboard computer processors, memory, and the communications adapters (similar to on-unit computer 120a). Regardless of construction, the sensors and/or sensor assembly together function to record, store, and report information to the computers 120. Any given sensor may record or the sensor assembly may append to recorded data a time stamps for when data was recorded.

The sensor assembly 110 may include its own network adapter (not shown) that communicates with the computers 120 through either a wired or wireless connection. For wireless connections, the network adapter may be a Bluetooth Low Energy (BTLE) wireless transmitter, infrared, or 802.11 based connection. For wired connection, a wide variety of communications standards and related architecture may be used, including Ethernet, a Controller Area Network (CAN) Bus, or similar.

In the case of a BTLE connection, After the sensor assembly 110 and on-unit computer 120a have been paired with each other using a BLTE passkey, the sensor assembly 110 automatically synchronizes and communicates information relating to the excavation of a site to the on-site computer 120a. If the sensor assembly 110 has not been paired with the on-unit computer 120 prior to the excavation of a site, the information is stored locally until such a pairing occurs. Upon pairing, the sensor assembly 110 communicates any stored data to the on-site computer 120a.

The sensor assembly 110 may be configured to communicate received data to any one of the controller 150 of the excavation vehicle 115, the on-unit computer 120a, as well as the off-unit computer 120b. For example, if the network adapter of the sensor assembly 110 is configured to communicate via a wireless standard such as 802.11 or LTE, the adapter may exchange data with a wireless access point such as a wireless router, which may in turn communicate with the off-unit computer 120b and also on-unit computer 120a. This type of transmission may be redundant, but it can help ensure that recorded data arrives at the off-unit computer 120b for consumption and decision making by a manual operator, while also providing the data to the on-unit computer 120a for autonomous or semi-autonomous decision making in the carrying out of the excavation plan.

I.C. on-Unit Computer

Data collected by the sensors 170 is communicated to the on-unit computer 120a to assist in the design or carrying out of an excavation routine. Generally, excavation routines are sets of computer program instructions that, when executed control the various controllable inputs of the excavation vehicle 115 to carry out an excavation-related task. The controllable input of the excavation vehicle 115 may include the joystick controlling the drive system 210 and excavation tool and any directly-controllable articulable elements, or some controller 150 associated input to those controllable elements, such as an analog or electrical circuit that responds to joystick inputs.

Generally, excavation-related tasks and excavation routines are broadly defined to include any task that can be feasibly carried out by an excavation routine. Examples include, but are not limited to: dig site preparation routines, digging routines, fill estimate routines, volume check routines, dump routines, wall cutback routines, backfill/compaction routines. Examples of these routines are described further below. In addition to instructions, excavation routines include data characterizing the site and the amount and locations of earth to be excavated. Examples of such data include, but are not limited to, a digital file, sensor data, a digital terrain model, and one or more target tool paths. Examples of such data are further described below.

The excavation vehicle 115 is designed to carry out the set of instructions of an excavation routine either entirely autonomously or semi-autonomously. Here, semi-autonomous refers to an excavation vehicle 115 that not only responds to the instructions but also to a manual operator. Manual operators of the excavation vehicle 115 may be monitor the excavation routine from inside of the excavation vehicle using the on-unit computer 120a or remotely using an off-unit computer 120b from outside of the excavation vehicle, on-site, or off-site. Manual operation may take the form of manual input to the joystick, for example. Sensor data is received by the on-unit computer 120a and assists in the carrying out of those instructions, for example by modifying exactly what inputs are provided to the controller 150 in order to achieve the instructions to be accomplished as part of the excavation routine.

The on-unit computer 120a may also exchange information with the off-unit computer 120b and/or other excavation vehicles (not shown) connected through network 105. For example, an excavation vehicle 115 may communicate data recorded by one excavation vehicle 115 to a fleet of additional excavation vehicle 115s that may be used at the same site. Similarly, through the network 105, the computers 120 may deliver data regarding a specific site to a central location from which the fleet of excavation vehicle 115s are stored. This may involve the excavation vehicle 115 exchanging data with the off-unit computer, which in turn can initiate a process to generate the set of instructions for excavating the earth and to deliver the instructions to another excavation vehicle 115. Similarly, the excavation vehicle 115 may also receive data sent by other sensor assemblies 110 of other excavation vehicles 115 as communicated between computers 120 over network 105.

The on-unit computer 120a may also process the data received from the sensor assembly 110. Processing generally takes sensor data that in a “raw” format may not be directly usable, and converts into a form that useful for another type of processing. For example, the on-unit computer 120a may fuse data from the various sensors into a real-time scan of the ground surface of the site around the excavation vehicle 115. This may comprise fusing the point clouds of various spatial sensors 130, the stitching of images from multiple imaging sensors 135, and the registration of images and point clouds relative to each other or relative to data regarding an external reference frame as provided by position sensors 145 or other data. Processing may also include up sampling, down sampling, interpolation, filtering, smoothing, or other related techniques.

I.D. Off-Unit Computer

The off-unit computer 120b includes a software architecture for supporting access and use of the excavation system 100 by many different excavation vehicles 115 through network 105, and thus at a high level can be generally characterized as a cloud-based system. Any operations or processing performed by the on-unit computer 120a may also be performed similarly by the off-unit computer 120b.

In some instances, the operation of the excavation vehicle 115 is monitored by a human operator. Human operators, when necessary, may halt or override the automated excavation process and manually operate the excavation vehicle 115 in response to observations made regarding the features or the properties of the site. Monitoring by a human operator may include remote oversight of the whole excavation routine or a portion of it. Human operation of the excavation vehicle 115 may also include manual or remote control of the joysticks of the excavation vehicle 115 for portions of the excavation routine (i.e., preparation routine, digging routine, etc.). Additionally, when appropriate, human operators may override all or a part of the set of instructions and/or excavation routine carried out by the on-unit computer 120a.

I.E. General Computer Structure

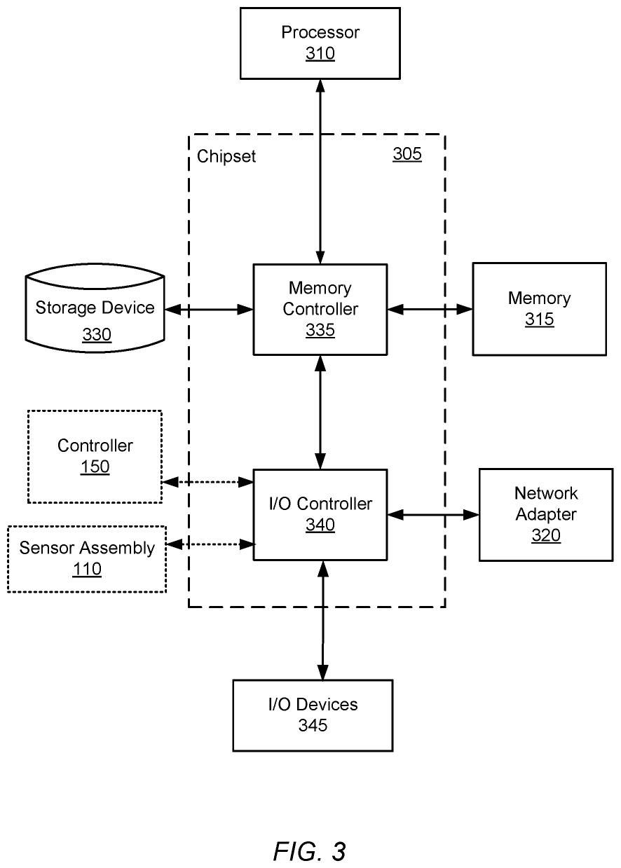

The on-unit 120a and off-unit 120b computers may be generic or special purpose computers. A simplified example of the components of an example computer according to one embodiment is illustrated in FIG. 3.

FIG. 3 is a high-level block diagram illustrating physical components of an example off-unit computer 120b from FIG. 1, according to one embodiment. Illustrated is a chipset 305 coupled to at least one processor 310. Coupled to the chipset 305 is volatile memory 315, a network adapter 320, an input/output (I/O) device(s) 325, and a storage device 330 representing a non-volatile memory. In one implementation, the functionality of the chipset 305 is provided by a memory controller 335 and an I/O controller 340. In another embodiment, the memory 315 is coupled directly to the processor 310 instead of the chipset 305. In some embodiments, memory 315 includes high-speed random access memory (RAM), such as DRAM, SRAM, DDR RAM or other random access solid state memory devices.

The storage device 330 is any non-transitory computer-readable storage medium, such as a hard drive, compact disk read-only memory (CD-ROM), DVD, or a solid-state memory device. The memory 315 holds instructions and data used by the processor 310. The I/O controller 340 is coupled to receive input from the machine controller 150 and the sensor assembly 110, as described in FIG. 1, and displays data using the I/O devices 345. The I/O device 345 may be a touch input surface (capacitive or otherwise), a mouse, track ball, or other type of pointing device, a keyboard, or another form of input device. The network adapter 320 couples the off-unit computer 120b to the network 105.

As is known in the art, a computer 120 can have different and/or other components than those shown in FIG. 2. In addition, the computer 120 can lack certain illustrated components. In one embodiment, a computer 120 acting as server may lack a dedicated I/O device 345. Moreover, the storage device 330 can be local and/or remote from the computer 120 (such as embodied within a storage area network (SAN)), and, in one embodiment, the storage device 330 is not a CD-ROM device or a DVD device.

Generally, the exact physical components used in the on-unit 120a and off-unit 120b computers will vary. For example, the on-unit computer 120a will be communicatively coupled to the controller 150 and sensor assembly 110 differently than the off-unit computer 120b.

Typically, the off-unit computer 120b will be a server class system that uses powerful processors, large memory, and faster network components compared to the on-unit computer 120a, however this is not necessarily the case. Such a server computer typically has large secondary storage, for example, using a RAID (redundant array of independent disks) array and/or by establishing a relationship with an independent content delivery network (CDN) contracted to store, exchange and transmit data such as the asthma notifications contemplated above. Additionally, the computing system includes an operating system, for example, a UNIX operating system, LINUX operating system, or a WINDOWS operating system. The operating system manages the hardware and software resources of the off-unit computer 120b and also provides various services, for example, process management, input/output of data, management of peripheral devices, and so on. The operating system provides various functions for managing files stored on a device, for example, creating a new file, moving or copying files, transferring files to a remote system, and so on.

As is known in the art, the computer 120 is adapted to execute computer program modules for providing functionality described herein. A module can be implemented in hardware, firmware, and/or software. In one embodiment, program modules are stored on the storage device 330, loaded into the memory 315, and executed by the processor 310.

I.F. Network

The network 105 represents the various wired and wireless communication pathways between the computers 120, the sensor assembly 110, and the excavation vehicle 115. Network 105 uses standard Internet communications technologies and/or protocols. Thus, the network 105 can include links using technologies such as Ethernet, IEEE 802.11, integrated services digital network (ISDN), asynchronous transfer mode (ATM), etc. Similarly, the networking protocols used on the network 150 can include the transmission control protocol/Internet protocol (TCP/IP), the hypertext transport protocol (HTTP), the simple mail transfer protocol (SMTP), the file transfer protocol (FTP), etc. The data exchanged over the network 105F can be represented using technologies and/or formats including the hypertext markup language (HTML), the extensible markup language (XML), etc. In addition, all or some links can be encrypted using conventional encryption technologies such as the secure sockets layer (SSL), Secure HTTP (HTTPS) and/or virtual private networks (VPNs). In another embodiment, the entities can use custom and/or dedicated data communications technologies instead of, or in addition to, the ones described above.

### II. Excavation Vehicle Operation Overview

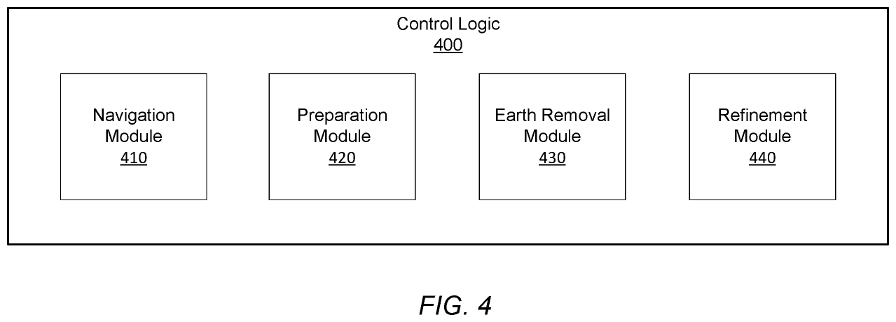

FIG. 4 is a diagram of the system architecture for the control logic 500 of an excavation vehicle 115, according to an embodiment. The control logic 500 is implemented by software within the on-unit computer 120a and is executed by providing inputs to the controller 150 to control the control inputs of the vehicle 115 such as the joystick. The system architecture of the control logic 500 comprises a navigation module 510, a preparation module 520, an earth removal module 530, a volume check module 540, and a soil property module 550. In other embodiments, the control logic 500 may include more or fewer modules. Functionality indicated as being performed by a particular module may be performed by other modules instead.

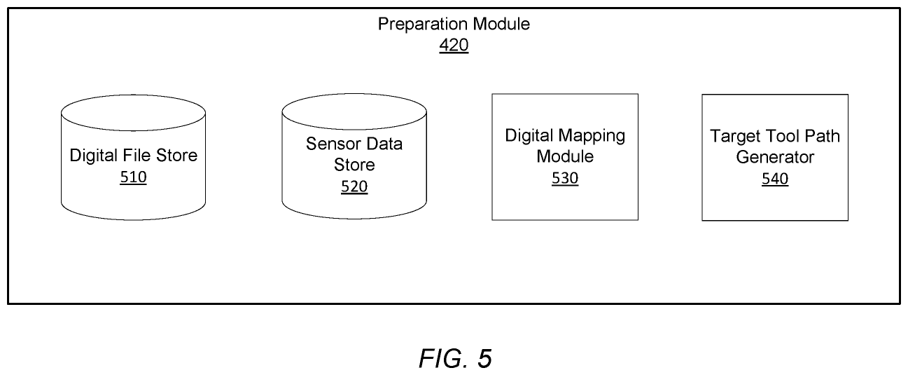

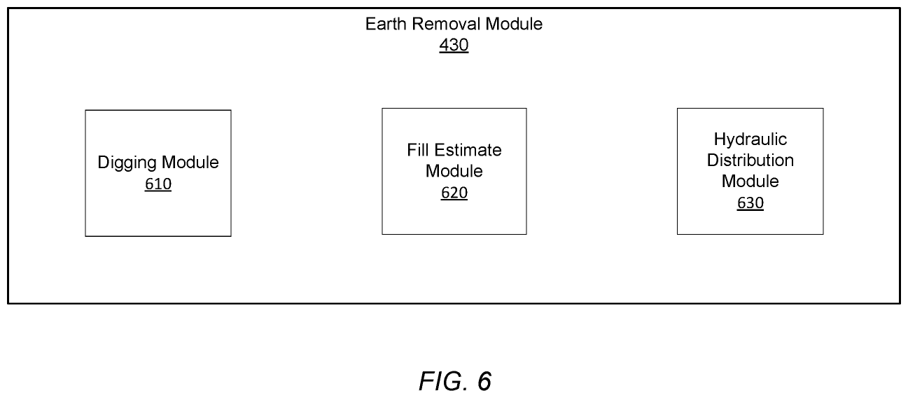

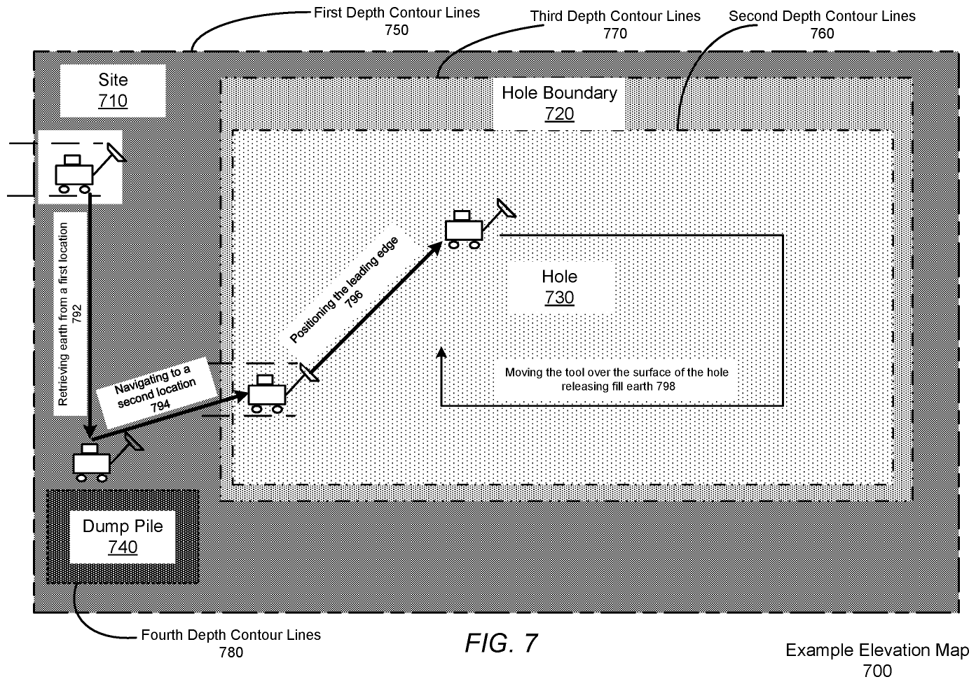

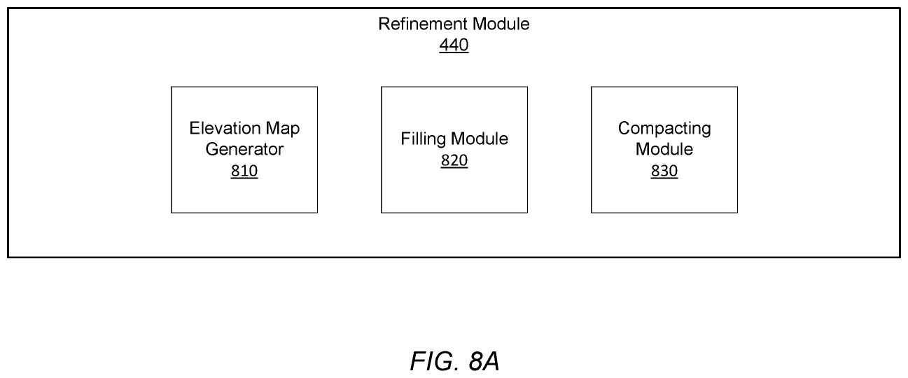

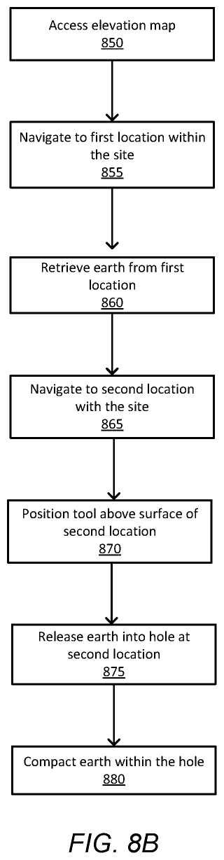

The navigation module 510 is responsible for providing mapping and orientation instructions to the drivetrain 210 of the excavation vehicle 115, allowing the vehicle to navigate through the coordinate space of the site and along the target tool paths within the hole. The preparation module 420 creates and/or converts the digital file describing the target state of the site into a set of target tool paths and the dump site as will be further described in reference to FIG. 5. The earth removal module 430 executes instructions to perform digging routines in order to physically excavate earth from the hole as will be further described in reference to FIG. 6. The refinement module 440 reviews the conditions of the site after excavation of the hole has been completed as will be further described in reference to FIGS. 7-8B. The refinement module 440 may identify locations within the site from which too much earth has been excavated and must be filled or locations within the site from which not enough earth has been removed and may be further removed.

As the excavation vehicle 115 navigates within the site, the position and orientation of the vehicle and tool is dynamically updated within the coordinate space representation maintained by the computer 120. Using the information continuously recorded by the sensors 170, the computer 120 is able to record the progress of the excavation tool path or route being following by the excavation vehicle in real-time, while also updating the instructions to be executed by the controller.

To determine the position of tool within the three-dimensional coordinate space, the computer 120 may use the sensors 170 to correlate changes in the information recorded by the sensors with the position of the tool in the coordinate space by referencing a parametric model or lookup table. The computer 120 generates lookup tables by measuring the output of sensors at various positions of the tool and correlating the outputs of the sensors with the positions of the tool. For example, at a depth of 1 meter, the tool is located at a position 5 meters perpendicular to the ground. The correlation between the depth measurement recorded by the spatial sensor 130 and the position measurement recorded by the position sensor 145 is stored within the lookup table. The referenced lookup table may differ depending on the type of sensor used and the format of the output provided.

In one implementation, the absolute position of the excavation vehicle 115 within the coordinate space is measured using one or more global positioning sensors mounted on the tool. To determine the position of the tool in a three-dimensional coordinate space relative to the excavation vehicle, the computer 120 accesses additional information recorded by the sensors 170. In addition to the absolute position of the excavation vehicle 115 measured using the global positioning sensor, the computer 120 performs a forward kinematic analysis on the tool and maneuvering unit of the excavation vehicle 115 to measure the height of the tool relative to the ground surface. Further, one or more additional position sensors mounted on tool measure the orientation of a leading edge of the tool relative to the ground surface. The leading edge describes the edge of the tool that makes contact with the ground surface. The computer 120 accesses a lookup table and uses the absolute position of the excavation vehicle 115, the height of the tool, and the orientation of the leading edge of the tool as inputs to determine the position of the tool relative to the excavation vehicle 115.

### III. Dig Site Preparation Routine

Prior to the excavation vehicle 115 executing the set of instructions to navigate through the site and excavate earth from the site (i.e., removing earth from a location or moving earth to a location), the excavation vehicle 115 generates the set of instructions based on a known target state of the site and contextual data describing the initial state of the site. FIG. 5 is a diagram of the system architecture for the preparation module 420 of an on-site or off-unit computer 120, according to an embodiment. The preparation module 420 generates a digital terrain model detailing one or more plurality of target tool paths which can be followed by the excavation vehicle 115. The system architecture of the preparation module 420 comprises a digital file store 510, a sensor data store 520, a digital mapping module 540, and a target tool path generator 550. In other embodiments, the preparation module 420 may include more or fewer modules. Functionality indicated as being performed by a particular module may be performed by other modules instead. Some of the modules of the preparation module 410 may be stored in the control logic 500.

The digital file store 510 maintains one or more digital files, accessed from a remote database. In some instances, the controller 150 may access these digital files from an off-unit computer 120b and subsequently store them in the digital file store 510. Digital files may be represented as image files describing the geographic layout of the site as a function of location within the coordinate space of the site, with different images representing a hole, dump pile, an entry ramp, etc. Geographic locations in the coordinate space may be represented as one or more two or three-dimensional points. The digital file may also include data describing how the excavation vehicle 115 ought to interact with each location discussed in the digital file. The digital files stored in the digital file store 610 may also include a digital file representing a target state of the site once all excavation has been completed. Digital files may be constructed using known computer programs and file types, such as a Computer Aided Design (CAD) file or a Building Information Modeling (BIM) file. For example, the hole may be characterized by a set of target volume dimensions which should be achieved upon the conclusion of the excavation routine. At a boundary of the hole, the digital file may also include a ramp. Additionally, the location of one or more dump piles may be extracted from the digital file or received manually from a human operator.

A representation of the initial state of the site is generated using sensor 170 data, stored within the sensor data store 520. As the navigation module 410 maneuvers the excavation vehicle 115 through the site, sensors 170 gather contextual information on the site which is aggregated into a representation of the current state of the site. More specifically, spatial sensors 130 record spatial data in the form of point cloud representations, imaging sensors 135 gather imaging data, and depth sensors 145 gather data describing relative locations as well as information about the terrain within the site, information about features within the site, and the elevations of obstacles in the site. More generally, the sensor data store 520 stores contextual information describing the current state of the site which refers to the physical landscape of the site and the physical properties of the soil within the site. The navigation module 410 navigates within the geospatial boundaries defined by the digital file to record contextual information describing the current state of the site.

When recording data via one or more spatial sensors, the spatial sensors 130 record one or more photographic images of various portions of the site and stitch the recorded images into one or more point clouds of data representing the portions of the site to generate a representation of a current physical state of the site. Additionally, for each of the recorded images, the position and orientation of features within the site are recorded and translated into the point cloud representations with respect to the coordinate space of the digital file. In alternative instances, the sensor assembly 110 uses an imaging sensor 135 to record the contextual information as photographic images of portions of the site and, for each of those images, stores the associated positions and orientations of the relevant features within the portion of the site. Additionally, for each of the recorded images, the position and orientation of features within the site are recorded and translated into the point cloud representations with respect to the coordinate space of the digital file. In alternative instances, the sensor assembly 110 uses an imaging sensor 135 to record the contextual information as photographic images of portions of the site and, for each of those images, stores the associated positions and orientations of the relevant features within the portion of the site. In another implementation, the excavation vehicle 115 includes sensors and a software assembly that generates a digital terrain model of the site using simultaneous localization and mapping (SLAM).

Using the generated representation of a current physical state of the site generated based on the sensor data and the representation of the target state of the site, the digital mapping module 530 generates a digital terrain model of the site. By aligning in the coordinate space of the site, the target state of the site with the initial state of the site, differences between the two representations can be identified by the computer 120. For example, the computer 120 may determine a volume of earth to be excavated to form the planned hole from the digital file. In one embodiment, the two representations (the digital file and the contextual data) are aligned (or register) using the known locations of fiducials and other locations within the site common to both representations. Position data from a position sensor 145 such as a GPS may also be used to perform the alignment. Algorithms, such as Iterative Closest Point (ICP) may be used to align the two representations. The boundaries of the sites provided by both representations may also be used to perform the alignment. In one embodiment, for every point pair in the actual/target representations, if the difference in elevation (e.g., Z-axis relative to the ground plane) is greater than a threshold, it is multiplied by the resolution of the representation to calculate a voxel volume, and is then summed together. This can be performed at multiple points to determine how the two representations should be adjusted relative to each other along an axis to align them.

In some implementations, the computers 120 use the digital terrain model to determine the difference in volume between the two representations which translates into the volume of earth to be excavated from the hole. Incorporating all the considerations made above, the physical layout of the site, the volume of earth to be excavated, and the creation of cutbacks and slope backs, the computer 120 generates 685 one or more target tool paths.

Using the digital terrain model, the target tool path generator 540 generates one or more target tool paths for the excavation vehicle 115 to move a tool over in order execute a part of the excavation routine, for example excavating a volume of earth, filling a volume of earth, or navigating the excavation vehicle 115 within the site. Tool paths provide geographical steps and corresponding coordinates for the excavation vehicle 115 and/or excavation tool to traverse within the site. When the site is represented in the digital terrain model as a coordinate space, as described above, a target tool path include a set of coordinates within the coordinate space. A target tool path may further represent a measure of volume relative to the volume of the planned hole. For example, if a hole is 4″ wide, 3″ long, and 2″ deep, a single target toolpath includes coordinates within the 12″ area of the coordinate space and, at each coordinate, places the tool at a depth of 2″ in order to excavate the hole using a single target tool path. Target tool paths may describe a variety of shapes representing a variety of excavation techniques, for example substantially rectangular pathways in two dimensions, substantially triangular pathways in two dimensions, hyperrectangular pathways in three dimensions, hyperrectangular pathways in three dimensions, elliptic pathways in two dimensions, hyperelliptic pathways in three dimensions, or curved lines along the plane of the ground surface.

For holes of greater volumes or requiring a graded excavation, multiple target tool paths may be implemented at different offsets from the finish tool path. For example, if three target tool paths are required to excavate a 6″ deep hole, the first may be executed at a depth of 3″, the second at a depth 2″, and the third at a depth of 1″. As a result, a target tool path may represent only a fraction of the volume of excavated earth. For example, the last tool path used at the conclusion of the excavation of the hole may be referred to as a finish tool path, which digs minimal to no volume and which is used merely to even the surface of the bottom of the dug hole. While moving through the finish tool path, the tool excavates less earth from the hole than in previous tool paths by adjusting the depth of the leading edge or the angle of the tool beneath the ground surface. To conclude the digging routine, the excavation vehicle 115 adjusts a non-leading edge of the tool and reduces the speed of the drive.

For holes of greater volumes or requiring a graded excavation, multiple tool paths may be implemented at different offsets from the finish tool path. For example, if three tool paths are required to excavate a 6″ deep hole, the first may be executed at a depth of 3″, the second at a depth 2″, and the third at a depth of 1″. As a result, a tool path may represent only a fraction of the volume of excavated earth. In one embodiment, the number of tool paths may be calculated by dividing the target depth of the hole by the maximum depth that each tool path is capable of In some instances, the maximum depth that each tool path is capable of is also defined by the dimensions of the tool 175 attached to the excavation vehicle 115. In other embodiments, the tool paths may be manually generated using the off-unit computer 120b.

Additionally, tool paths may not describe the shape of the hole in three-dimensions, instead removing the depth measurement to only specify a two-dimensional pathway or two-dimensional plane in the three or two dimensional coordinate system. In such instances, the depth instructions for how deep to dig with a tool path may be provided for separately in the set of instructions.

Tool paths are defined based on several factors including, but not limited to, the composition of the soil, the properties of the tool being used to excavate the hole, the properties of the drive system 210 moving the tool, and the properties of the excavation vehicle 115. Example properties of the excavation tool 175 and excavation vehicle 115 include the size of the tool, the capacity of the tool, the weight of the excavation tool, and the force exerted on the excavation tool 175 in contact with the ground surface of the site.

When executed in reverse or in alternative sequences, the processes described above and below with respect to filling and compacting as specific examples may also perform other excavation routines including, but not limited to, digging and grading. Similarly, the processes described above and below with respect to digging may also perform other excavation routines including, but not limited to, filling and compacting.

### IV. Earth Removal Routine

By following target tool paths generated by the preparation module 510, the excavation vehicle 115 is able to navigate through the site to remove volumes of earth such that the site begins to resemble the digital file received by the digital mapping module. FIG. 6 illustrates a diagram of the system architecture for the earth removal module 520 of an excavation vehicle 115, according to an embodiment. The earth removal module 520 executes a set of instructions for guiding the tool through an excavation routine to excavate earth from various locations within the site, for example the hole. The instructions cause the controller 150 to control the tool 175 to be lowered into contact with the ground surface and then advanced (directly or indirectly by moving the entire vehicle 115 with the drive train 210) forward to excavate earth from the ground into the tool. The system architecture of the earth removal module comprises a digging module 610, a fill estimate module 620, and a hydraulic distribution module 630. In other embodiments, the earth removal module 530 may include more or fewer modules. Functionality indicated as being performed by a particular module may be performed by other modules instead. Some of the modules of the earth removal module 520 may be stored in the control logic 500.

The digging module 610 executes a digging routine to excavate a volume of earth from the planned hole or areas within the site, consistent with a provided set of instructions and the target tool path. The digging module 610 executes a digging routine by accessing one or more target tool paths of an excavation routine, for example as generated by the preparation module 520, and moves the tool 175 and/or vehicle 115 accordingly. The digging module 710 may also continuously or periodically track the position of the tool within the coordinate space using information obtained from the position sensor 145. Based on the instructions and the target tool path generated by the target tool path generator 540, the digging module 610 positions the leading edge of the tool below the ground surface. The depth below the ground surface at which the tool is placed is guided by the set of instructions received from the controllers 120. The set of instructions may also instruct the digging module to 610 to maintain the tool at a depth below the ground surface over a distance of time. To maintain the tool, the digging module 610 dynamically adjusts mechanical conditions of the excavation vehicle 115 including, but not limited to, the angle of the tool beneath the ground surface, the torque output of the engine system, and the true speed of the tool. The angle of the tool beneath the ground surface can be adjusted to reduce the rate at which the tool collects excavated earth. Additionally, at lower speeds, the tool is generally often better able to maintain the angle optimal for excavating earth.

While moving through the excavation routine for the planned hole, the digging module 610 tracks the position and orientation of the tool within the coordinate system using the position sensors 145 physically mounted on the excavation vehicle 115 as described above in reference to FIG. 3A-3B. The orientation of the tool, described in reference to the angle of the tool relative to a reference orientation, is recorded using one or more position sensors 145. Examples of reference orientations include the ground surface, a gravity vector, or a target tool path. To track the positioning of the tool beneath the ground surface, the digging module 610 may utilize several methods to record the relative position of the leading edge within the coordinate spaces of the digital terrain model of the site. In some implementations, the relative position of the leading edge is recorded relative to the position of the excavation vehicle within the site. Examples of the methods used to track the relative position of the leading edge include, but are not limited to, using a global positioning system mounted to the tool, using a measurement sensor mounted to the excavation tool 175, using a linear encoder mounted to the excavation vehicle 115, measuring the pressure on the hydraulic system controlling the tool, using a spatial sensor mounted to the excavation vehicle 115. Additionally, the digging module 610 may use a sensor (such as a measurement sensor) mounted to the excavation vehicle 115 to measure the relative position of the tool and convert that measurement into an absolute position using a lookup table stored by the computers 120 or by using forward kinematics characteristic of the excavation tool and the soil composition surrounding the site. The sensor assembly 105 may also measure the quantity of earth in or acted upon by the tool or the quantity of earth remaining in the site, and use that information along with information from the digital terrain model to determine the absolute position as a function of the amount of earth removed/remaining.

Periodically while moving through the actual tool path, the digging module 610 updates the tool fill level and records the speed of both the tool and the drive system. Based on these recorded considerations, the digging module 610 either continues to move the tool through the earth or exits the digging routine to execute a check routine. With the conclusion of an actual tool path, the controller 150 may update the tool fill level, before continuing with the excavation routine for the planned hole.

The digging module 610 may also execute a grading routine to perform grading tasks. A grading routine may, for example, include moving the tool forward through the hole to grade the ground surface of the hole where the tool is set at a shallow or zero depth position relative to the aggregate or average ground plane. At such a shallow depth, the tool requires less forward force from the drive system 210 to move the tool forward than when the tool is lowered to a greater, digging-oriented depth. This allows the excavation vehicle 115 to be fitted with a tool suited to grading, such as a tool of greater volume relative to a digging routine oriented tool, which would be able to hold a greater amount of earth within the mechanical and hydraulic constraints of the excavation vehicle 115 and while also requiring fewer dump routines for dumping excess graded earth.

Prior to executing a check routine and going to the trouble of interrupting a target tool path execution and raising the tool above the ground surface, the fill estimate module 620 may execute a fill estimate routine by estimating the tool fill level, which describes the volume of earth in the tool, without interrupting the movement of the tool within the target tool path. The fill estimate module 730 determines an estimate of the volume of earth in-situ as the tool is moved over a distance along the target tool path. The fill estimate module 730 compares the estimate to a threshold volume of earth. When the estimated volume is greater than the threshold volume, the fill estimate module 730 halts the digging routine and raises the tool above the ground surface and executes a check routine to better estimate the amount of earth currently in the tool.

The fill estimate module 620 estimates the volume by mathematically integrating the depth of the leading edge beneath the ground surface over the distance traveled by the tool over the target tool path. In another implementation, the fill estimate module 620 may estimate the volume of earth in the tool. In another implementation, the fill estimate module 620 uses the point cloud representation of the current state of the site gathered using one or more spatial sensors to determine a pre-excavation volume of earth in the hole and accesses, from the computers 120 or a remote server, a swell factor of the earth relating the volume of earth in the tool to the pre-excavation volume of earth in the hole. Using the pre-excavation volume of earth in the hole and the swell factor characteristic of the earth, the fill estimate module 620 may estimate the volume of earth in the tool. In another technique, the fill estimate module 620 uses the sensor assembly 105 to measure the quantity of earth accumulated in front of the leading edge of the tool while the tool is in the position set by the currently-in-progress target tool path. The fill estimate module 620 may also use measurement sensors to measure the force of earth acting on the tool beneath the surface and adjust the angle of the tool to estimate the fill level of the tool.

As another technique, the fill estimate module 620 may access a previously trained prediction model that is capable of receiving as input the distance traveled by the tool along with other parameters of the vehicle 116 and excavation routine and outputting an estimated amount of earth in the tool. These other parameters include, but are not limited to, any sensor value, the tool type and width, the vehicle type, and the depth of the leading edge of the tool below the ground surface during the target tool path. The trained prediction model may further be capable of generating a trend line that extrapolates tool fill level as a function of distance traveled, which may in turn be used to generate an estimate when to initiate a check or dump routine. Alternately, the prediction model may generate such an estimate directly.

The fill estimate module 620 compares the fill estimate to a threshold volume. The threshold volume may be the maximum available volume of the tool, a volume set manually by a human operator, a volume set by a calibration procedure using the tool in an empty state, or another volume. When the estimated volume is greater than the threshold volume, the excavation vehicle adjusts the angle of the tool towards the breakout angle and raises the tool above the ground surface. The breakout angle refers to the threshold angle of the tool at which the tool is capable for breaking through the ground surface during the digging routine.

Alternatively, when the estimated volume is less than the threshold volume, the fill estimate module 620 continues the digging routine by calculating the remaining distance for the tool to traverse in order to be filled at maximum capacity while staying within the target parameters of the digital file using a trend line generated by the prediction model.

After calculating the remaining distance to be traveled, the fill estimate module 620 traverses the remaining distance and estimates a new volume of earth in the tool. As with the previous volume estimate, the updated volume estimate is repeatedly compared to the threshold volume. When the estimated volume is greater than the threshold volume, the controller 150 executes a dump routine and releases 790 earth from the excavation tool.

The hydraulic distribution module 630 monitors and adjusts the distribution of hydraulic pressure from the engine that is allocated between the drive system 210 and tool 175. The hydraulic distribution module 630 does this in response to instructions from another module (such as the digging module 610) attempting to carry out the excavation routine, as control of the hydraulic pressure dictates the actuation of the tool 175 and movement of the vehicle 115. In practice, the digging module 610 may specify some device parameter to be maintains, such as the tool 175 breakout angle, and the hydraulic distribution module 610 sets the hydraulic distribution between the tool 175 and drive system 210 to maintain that breakout angle.

Generally, the excavation vehicle only has sufficient hydraulic pressure to power a single system at full capacity. As a result, both the drive and tool systems may be powered equivalently at half capacity. However, if, based on soil friction, forces, speeds, tool angles, or other conditions, the angle and depth of the tool cannot be maintained at half capacity, the hydraulic distribution module 740 may redistribute the hydraulic pressure within the system to favor the tool over the drive system (e.g., 75%-25% distribution, or otherwise). The calibration for the hydraulic system may be performed by observing joystick manipulations within the excavation vehicle and recording the changes in pressure distribution.

In moving the tool through the target tool path, the hydraulic distribution module 630 measures the speed of the tool and compares it to a target speed. The target speed refers to the speed that the drive system 210 is traveling. This may be calculated based on the knowledge of the earth of the site exhibiting an industry standard soil friction or a soil friction determined specifically for the excavation vehicle 115, site, or even specific target tool path being executed. If the measured speed is lower than the target speed, the hydraulic distribution module 740 may determine that the soil friction (or force of soil exerted on the tool) is greater than expected, and adjusts the distribution of hydraulic pressure between the drive system and the tool to favor the tool to reduce the increase the speed of the tool. While this may be accomplished in some instances by increasing the amount of hydraulic pressure capacity allocated to the drive system, the amount of hydraulic capacity available is finite and so this is not always a viable solution. Often, greater than expected soil friction is due to the tool being too deep (or angled along a path proceeding downward), thus generating more friction and often causing the tool to fall off the target tool path. To compensate, the hydraulic distribution module 740 may adjust the tool to a shallower depth or angle, which will accomplish reducing the soil friction and raising tool speed. This process may play out in reverse for a tool speed greater than expected, which may be adjusted by lowering the tool or setting it at a deeper angle.

The maintenance of the hydraulic capacity in this manner and as described elsewhere herein prevents the excavation from stalling during the excavation routine or from complications regarding raising the excavation tool above the ground surface. In one embodiment, to further maintain sufficient hydraulic capacity for it to be possible to make adjustments to the position and orientation of the tool during the digging routine, the hydraulic distribution module 630 maintains hydraulic pressure within the hydraulic system below a threshold 90% of the maximum hydraulic pressure capacity.

A breakout event and corresponding breakout angle may be recorded as a result of the tool naturally breaking through the ground surface during the digging routine. At speeds below the target speed and/or at forces above the threshold force, the tool is unable to collect earth and break out of the ground surface. Similarly, at speeds above the target speed and forces below the threshold force, the tool inefficiently collects earth. As referenced above, forces refer to the forces exerted by the earth on the tool. Breakouts and the speeds and forces that cause them are addressed by module 630 to resume digging if they do occur and hopefully reduce their occurrence overall. This may involve the hydraulic distribution module 630 measuring the force of earth on the tool and adjusting the distribution of pressure so that the tool angle has sufficient hydraulic pressure to be adjusted beneath the ground surface. The tool may be lowered or angled downward to dig more deeply in cases of high speed/low force, and angled upward/raised to dig more shallowly in cases of low speed/high force. Additionally, as the tool moves through the target tool path and collects earth, the excavation vehicle may continuously adjust the angle of the tool and if the tool eventually breaks out of the ground surface, the excavation vehicle 115 records the breakout angle and may voluntarily opt to execute the volume check routine rather than resuming digging.

Additionally, the hydraulic distribution module 630 may use the received set of instructions to maintain the hydraulic capacity of the hydraulic system and decrease the target speed of the drive system 210 by adjusting the distribution of hydraulic pressures. A decrease in target speed results in a reduction of the overall hydraulic pressure in the hydraulic system, thereby ensuring sufficient scope in the hydraulic system to adjust the position and orientation of the tool and with minimal delay during the digging routine. For example, if the hydraulic pressure within the system is 98% of the maximum hydraulic pressure, exceeding the threshold hydraulic pressure, the hydraulic distribution module 740 can reduce the target speed of the excavation vehicle 115 by dynamically executing instructions to divert hydraulic pressure from the drivetrain to the set of tool actuators. By redistributing hydraulic pressure away from the certain components of engine system and towards other components of the engine system, the hydraulic distribution module 630 can prioritize certain excavation functions and maintain high excavation efficiency by the tool and excavation vehicle 115.

### V. Site Refinement Routine

V.D Site and Routine Overview

The descriptions above describing the navigation and adjustments of the excavation vehicle 115 and the excavation tool may also be used to carry out of a set of filling and compacting tasks performed simultaneously or subsequently to the digging routines described above. Accordingly, as described herein, an excavation routine describes any set of instructions which when implemented cause the excavation vehicle 115 to navigate within the site or adjust the position of the tool within the site in order to move or manipulate earth, for example filling earth into a sink or compacting recently filled earth.

FIG. 7 illustrates an example coordinate space in which an excavation vehicle 115 carries out a fill routine in a dig site 702, according to an embodiment. FIG. 7 may be a visual representation of the coordinate space from a digital detailing the excavation routine. The dig site as illustrated in FIG. 7 has already undergone a digging or grading routine, resulting in the presence of both a hole 730 from which earth was excavated and a dump pile 740 where the excavated earth was released. The digital file includes data describing the site 702, the location of the hole 730, and the location of the dump pile 740. The hole 730, bounded by the hole boundary 720, refers to a location within the site where the excavation vehicle 115 will perform the filling and compacting routine described by the set of instructions. Due to the previous excavation, the hole 730 describes a location within the site at an elevation below the ground surface. Similarly, the dump pile 740 refers to a location within the site where the excavation vehicle 115 previously released excavated earth held in the tool. As described herein, earth refers to the ground material and composition of a site, for example, soil, dirt, and gravel.

Additionally, areas within the site at different elevations may be represented in a contour map such that different elevations relative to the ground surface of the site 710. For example, the areas of the site which have been unaffected by the excavation routine may be represented by first depth contour lines 750. In such a representation, the first depth contour lines 750 represent the elevation of the ground surface. In more complex implementations, areas of the site unaffected by the excavation routine, may naturally include earth at a variety of elevations, resulting in a plurality of contour lines throughout the site 710. Once excavated, the hole 730 lies at a depth below the ground surface of the site represented by second depth contour lines 760. To separate the hole 730 from the site 710, earth from the hole boundary 720 may be excavated such that the hole boundary lies at a depth between the surface of the site 710 (as represented by the first depth contour lines 750) and the hole 730 (as represented by the second depth contour lines 760). The elevation of the hole boundary may accordingly be described third depth contour lines 770. As earth is excavated from the hole boundary 720 and the hole 730, the excavation vehicle 115 deposits earth at the dump pile 730, resulting in the dump pile gradually increasing to an elevation above the first depth contour lines of the site 710. Accordingly, the dump pile 740 is represented by fourth depth contour lines. As illustrated, the fourth depth contour lines 780 represent the greatest elevation within the site, followed by the first depth contour lines 750, the third depth contour lines 770, and the second depth contour lines 760. Sites with more complex distributions of earth prior to and post excavation, may be represented by a greater number of contour lines.

Walking through an example hypothetical excavation routine for the purpose of discussing the concepts introduced in FIG. 7, in one such routine the excavation vehicle is positioned at a location within the site 710, for example the entry ramp the site. After completing the excavation of the hole 730, the excavation vehicle 115 may detect elevations within the hole 730 describing areas from which too much earth was excavated or areas from which too little earth was excavated. In response to such detections, the excavation vehicle 115 navigates to a first location, for example the dump pile 740 or an alternate location which contains more earth than the amount prescribed by the digital file, and retrieves 792 earth from that first location. With the retrieved earth, the excavation vehicle 115 navigates 794 to a second location within the site at an elevation beneath the ground surface, for example the hole 730 or an alternate location which contains less earth than the amount prescribed by the digital file. The excavation vehicle follows a target tool path to position 796 the tool such that earth may be released from the tool into the second location and move 798 the tool over the surface of the second location such that earth fills the appropriate areas of the second location. Once the second location has been filled, the excavation vehicle 115 may execute an alternative target tool path to compact earth at the second location using the second location.

FIG. 8A is a diagram of the system architecture for the refinement module 440 of an excavation vehicle, according to an embodiment. The refinement module includes computer program instructions for carrying a number of tasks related to the context of removing earth, such as filling earth into regions of the site after earth has been excavated, where filling earth may include filling in subregions, leveling subregions, compacting earth, grading earth etc. Any of the particular tasks and corresponding instructions implemented within the refinement module may also be carried out separately, for example, filling and compacting may be performed as independent tasks in their own right apart from leveling. For filling as a specific example, the instructions of the module 440 cause the controller 150 to control the tool 175 to identify regions within the site below their target elevation, for example a sink, and retrieve earth from elsewhere within the site to fill the identified regions.

The logical architecture of the refinement module 440 comprises an elevation map generator 810, a filling module 820, and a compacting module 830. Functionality indicated as being performed by a particular module may be performed by other modules instead. Some of the modules of the refinement module 440 may be stored in the control logic 500.

The elevation map generator 810 receives the digital terrain model from the digital file store 510 and generates an elevation map of the digital terrain model describing current elevations for earth at a plurality of regions or features within the site. The elevation map may comprise an array of coordinate locations where each coordinate location is associated with an elevation at that location. For example, one coordinate location or set of coordinate locations may describe the dump pile which extends a height above the ground surface, while another set of coordinate locations may describe the hole which extends a depth below the ground surface. In one implementation, the elevation map is a three-dimensional representation of the site, such that the third dimension describes the height of features within the site relative to the ground surface, for example a three-dimensional contour map. In an alternate implementation, the elevation map is a two-dimensional representation of the site, such that the regions of the site are distinguished graphically (as illustrated in FIG. 7) based on their elevation relative to the ground surface, for example a two-dimensional topographical map. To generate the elevation map, the elevation map generator 810 receives spatial sensor data from spatial sensors 130 describing the elevation of various regions and features of the site identified during the generation of the digital terrain model. In one implementation, the excavation vehicle 115 records spatial sensor data required to generate the elevation map simultaneously with the sensor data required to generate the digital terrain model, but may alternatively record such data after the generation of the digital terrain model. Accordingly, the elevation map may resemble the digital terrain model supplemented with elevation data.

After generating the elevation map, the elevation map generator 810 compares the elevation map describing the current state of the site with the target elevations described in the digital terrain model. As a result, the elevation map generator 810 periodically updates the elevation map using spatial sensor data gathered during the execution of an excavation routine. For example, the digital file specifies a target depth for the hole to be 3 meters, while the elevation map may indicate a 0 meter depth of the hole prior to the excavation routine. As the excavation vehicle excavates the hole, the elevation map may be updated to record the changing depths of the hole, for example 1 meters, 2 meters, and 3 meters, until the excavation routine has concluded. At the conclusion of an excavation routine, the computer 120 identifies discrepancies between the elevations of features within the elevation map (actual outcome of excavation) and the digital file (desired outcome of excavation that may be addressed with small-scale movements of earth that may be carried out under the direction of the refinement module 440, specifically the filling module 820 and compacting module 830.

By comparing the elevation map with the digital file, the filling module 820 identifies two kinds of locations: locations that lie below the target elevation for their region, for example a sink in the ground surface, and any locations that lie above the target elevation for their region, for example a mound of earth. Although the illustration in FIG. 7 illustrates an exemplary process involving the hole, representing a location below a target elevation, and the dump pile representing a location above a target elevation, the techniques described below are applicable to any mound or sink within the site whether made accidently by the excavation vehicle 115 during the excavation routine, naturally or deliberately prior to the excavation routine, or naturally or deliberately during the excavation routine. The filling module 820 executes a set of instructions, or a fill routine, to retrieve earth from the site to address these elevations in discrepancies by either adding or removing earth to the location. As an additional example, once a foundation wall or retaining wall is constructed within a hole previously dug by the excavation vehicle 115 may retrieve earth from the dump pile and dispense the earth between the exterior foundation wall and the wall of the hole around the foundation wall according to the digital file of the site.

In more complex implementations, the filling module 820 identifies both sets of locations simultaneously and generates a complementary target tool path based on the two sets of locations. For example, the filling module 820 identifies a first location at an elevation above the target elevation and a second location at an elevation below the target elevation. Accordingly, the filling module 820 instructs the excavation vehicle 115 to remove earth from the first location and release it at the second location such that the elevation at the first location is reduced to match the target elevation simultaneously as the elevation at the second location is increased to match the target elevation for that region, resulting in a more efficient process.

At the first location, the filling module 820 employs the same hydraulic distribution techniques and principles as those described in Section IV with reference to the Earth Removal Routine to adjust the position of the excavation tool to retrieve earth from the first location. The navigation module 410 navigates the excavation vehicle 115 to the second location, where the excavation vehicle 115 positions the tool to release earth onto the first location. In some implementations, several iterations over the target tool path from the first location to the second location are required to fill an area to a target elevation. In such implementations, the filling module 820 determines a difference between the current elevation of the elevation map and the digital file above a threshold difference and instructs the excavation vehicle 115 to return to the first location to retrieve additional earth. After retrieving more earth from the first location, the excavation vehicle 115 returns to the second location and releases the earth. This process is iterated until the target elevations of both the first location and the second location are met.

In some implementations, the second location may require a smaller volume of earth be filled to meet the target elevation than the first location requires be removed to meet the target elevation. In such an implementation, the filling module 820 may further identify additional locations within the site below the target elevation and generate one or more additional target tool paths from the first location to each of additionally identified locations. Alternatively, the filling module 820 may generate a target tool path between the first location and the dump pile and release earth from the first location onto the dump pile. When the excavation vehicle 115 has filled earth at the second location to a target elevation, but the excavation tool still holds earth, the filling module 820 may instruct the excavation vehicle 115 to navigate to an additional location in proximity to the second location or the dump pile and release earth from the tool. Similarly, the second location may require a greater volume of earth be filled to meet the target elevation than the first location requires be removed to meet the target elevation. In such an implementation, the filling module 820 may identify additional locations within the site at elevations above a target elevation and generate target tool paths between the second location and each of the additional locations.

After the filling module 820 has adjusted the elevation of a feature to match the corresponding target elevation as indicated in the digital file, the compacting module 830 executes a set of instructions, or compaction routine, to compact earth filled into the sink or earth remaining from the mound into the ground surface. For example, the compacting module 830 may instruct the excavation vehicle 115 to adjust the position of the tool relative to the ground surface, in effect applying a force to the ground surface at the location using the excavation tool. The compacting module 830 instructs the excavation vehicle to manipulate the distribution of hydraulic pressure within the system to adjust the position of the excavation tool, for example a steamroller attachment, a sheepsfoot attachment, or a vibratory plate compactor, using the same principles as those described in reference to the earth removal module 430. In one implementation, the compacting module adjusts distribution of hydraulic pressure within the excavation vehicle 115 to maintain the speed of the excavation tool based on a measurement of the weight in the tool and the geometry of the leading edge of the tool. The compacting module 830 may retrieve a total weight and a leading edge profile, describing the number and width of the teeth extending from the leading edge of the tool, and calculate an entry speed of the bucket and a number of compaction routines to achieve the target compaction as a function of the density of the backfilled earth and the density of the compacted earth at the target compaction. For example, if the weight of earth in the tool is low, the excavation vehicle 115 moves the tool with greater force. If the geometry of the tool indicates that the leading edge is flat, the excavation vehicle 115 may adjust the movement of the tool compared to the movement of a curved leading edge. Additionally, if the leading edge of the toll has a large surface area, the compacting module 830 may adjust the distribution of hydraulic pressure to increase the speed with which the tool is moved. The compacting module 830 may distribute the calculated number of compaction cycles according to the calculated entry speed.

In one implementation, at the conclusion of a filling routine, the compacting module 830 identifies one or more of the filled locations whose elevation now exceeds the target elevation (i.e, the volume of filled earth results in that location now exceeding the target elevation). The compacting module executes a set of instructions referred to as a compaction routine to adjust the position of the tool to flatten the earth at such locations to meet the target elevation. The compacting module 830 repeats the instructions at each location exceeding the target elevation. In an alternate implementation, the compacting module 830 identifies locations within the site which, during a filling routine, were not filled uniformly or consistently (i.e., earth was released from the tool around the location to be filled rather than inside of the location). In such implementations, the compacting module 830 adjusts the excavation tool to collect and reposition earth around the filled location to within the filled location based on the target elevation.

In one implementation, the compacting module 830 instructs the excavation vehicle to adjust the position of the excavation tool such that the leading edge of the tool comes in contact with the location being compacted and repositions the excavation tool at a position above the ground surface of the location. Contact between the leading edge and the ground surface, with regards to the first location, may be measured using a measurement sensor 125. The compacting module 830 instructs the excavation vehicle 115 to oscillate the leading edge of the tool between the first position in contact with the ground surface and the second position above the ground surface to achieve a target compaction for earth at that location. Target compaction describes a predetermined change in the volume associated with earth at the second location. In some implementations, the target compaction may be determined on a case-by-case basis depending on the specific soil properties within the site, while in other implementations the target compaction is a predetermined value determined manually be a remote user. The target compaction or current compaction may be determined based on one or more of the following properties: a measurement of the density of earth prior to the execution of a compaction routine, the density of earth after the execution of a compaction routine, a measurement of the soil cohesion, and a measurement of the particles size of earth within the tool used to fill a sink. Compaction levels, whether a target compaction or a current compaction, may also be based on the types of earth at a location, for example soil, clay, and gravel.

In an alternate implementation, the compacting module 830 instructs the excavation vehicle 115 to adjust the position of the excavation tool such that the leading edge of the tool comes in contact with the location being compacted and maintain the position of the excavation tool while navigating over the surface of the location at a constant speed. The compacting module 830 identifies the most efficient combination of target tool paths to compact earth at a location within the site based on a several factors including, but not limited to, the configuration and organization of the site, the locations of obstacles within the site, and the turning radius of the equipment. For example, the compacting module 830 divides the location into linear strips and maneuvers the tool over each linear strip. Alternatively, the compacting module 830 may instruct the excavation vehicle 115 to navigate over a winding path, snaking over the surface of the location.

As described above, a compaction routine may be determined on a site-by-site basis. Before executing a compaction routine to achieve the target compaction, the compacting module must determine a current compaction level for earth at a location and or, more generally, for earth within the site. In addition to the target compaction from a computer 120, the compacting routine 830, receives a compaction graph relating the target compaction of earth within the site with a numerical change in the volume of earth at the location. The change in volume of earth represents the difference between the volume of earth around a location prior to the execution of a compaction routine and after the execution of a compaction routine. By reviewing the compaction graph, the compacting module determines intermediary levels of compaction leading to the target compaction and their associated changes in volume. For example, a compaction graph, at a target compaction of 1.0, indicates a change in volume of 0.3 meters. At a compaction of half the target compaction, the compaction graph indicates a change in volume of 0.15 meters. As a result, if the change in volume for earth at a location is known or determined, the compaction graph may be analyzed to determine the current compaction of earth at the location and the level of compaction required to achieve the target compaction. The current change in volume of earth at the second location may be measured using spatial sensors mounted to the excavation vehicle 115.

The compaction graph, as described above, may be generated by obtaining a plurality of samples of earth from the same location with the site and using the excavation tool to compact each sample to a different target compaction. The compacting module 830 receives a volume measurement for each sample from a spatial sensor mounted to the EV and determines a change in volume between the volume measurement of the sample after compaction and the initial volume measurement of the sample. The compacting module 830 generates a compaction graph by relating the plurality of target compactions with the determined change in volume, such that each sample represents an independent point on the graph.

The current change in volume of earth at the second location may be measured using a compaction probe and a compaction sensor mounted to the excavation vehicle 115, for example a nuclear densometer or a soil density gauge. The excavation vehicle 115 may be configured such that a detachable compaction probe and compaction sensor are mounted to the vehicle 115. The compacting module 830 instructs the compaction probe to detach from the excavation vehicle 115 and position itself at a depth below the ground surface of a location. Once in position, the compaction probe transmits a stream of particles, for example radioactive particles, through the ground surface and towards the compaction sensor mounted to the excavation vehicle 115. Because the compaction of earth at the location affects the amount of transmitted particles received by the compaction sensor, the compaction sensor is able to determine the level of compaction.

In some implementations to execute the set of instructions received from the compacting module 830, the excavation vehicle is outfitted with an alternative tool, for example a sheepsfoot roller, a steamroller, or a vibratory plate compactor.

III.B Process for Filling and Compacting Earth

To implement the system architecture of the refinement module, FIG. 8B shows an example flowchart describing the process by which the refinement module 440 fills sinks within the site and compacts the filled earth, according to an embodiment. The elevation map generator 810 generates an elevation map based on spatial data recorded by spatial sensors mounted to the excavation vehicle. The filling module 820 accesses 850 the elevation map and generates a set of instructions to guide the excavation vehicle between a first location with earth above a target elevation and a second location with earth below a target elevation. Accordingly, earth at the first location is positioned at an elevation greater than the elevation of the second location relative to the ground surface. In some implementations, the entirety of a site may be assigned a single target elevation, while in other implementations, specific locations of a site may be assigned a target elevation. Based on the instructions received from the filling module 820, the excavation vehicle 115 navigates 855 to the first location within the site and retrieves 860 earth from the first location.

The excavation vehicle 115 executes instructions from the filling module 820 to navigate 865 to the second location within the site and positions 870 the tool above the surface of the second location. When positioning the tool above the surface of the second location, the controller 120 may receive perception data recorded by sensors mounted to the excavation vehicle 115, for example an incline sensor, a linear encoder, or a spatial sensor, describing the position and orientation of the excavation vehicle 115 within the site. The digital terrain model, or virtual representation of the site, is updated accordingly to track and reflect the dynamic movement of the excavation vehicle 115 during the filling routine. Based on the updated position and orientation of the excavation vehicle 115, the filling module 820 positions the leading edge of the tool above the surface of the second location to release earth onto the second location.

The filling module 820 releases 875 earth onto the second location. As earth is released from the tool mounted to the excavation vehicle 115, the excavation vehicle 115 measures the volume of earth within the tool, or tool fill level, using spatial sensors mounted to the excavation vehicle 115. The spatial sensors measure the volume of earth being released from the tool without interrupting the movement of the excavation tool over the surface of the second location. After releasing the earth to raise the elevation of the second location to match the target elevation for that location, the excavation vehicle 115 executes a set of instructions to compact 880 the filled earth at the second location. compacting module 830 may implement closed-loop controls to control the entry speed of the leading edge of the tool as it makes contact with backfilled earth to achieve the target compact defined by the digital file based on properties of the filled earth. Too little compaction of the earth results in the backfilled earth slumping, but excessive compaction results in the cracking of the adjacent foundation or retaining wall. Within these parameters, the compacting module 830 may calculate a target compaction to yield less than 2″ of slumping over a five-year period based on the density, cohesion, and particle size of the loose earth retrieved from the dump pile and the depth and breadth of the hole to be filled. The calculation of the target compaction may be done using a lookup table or a parametric model.

In one implementation, the filling module 820 executes a filling routine to fill earth in a location within a threshold distance of the target elevation. Once the elevation of the filled earth has been measured, by a spatial sensor mounted to the excavation vehicle 115, to be within a threshold distance of the target elevation, the compacting module 830 may execute a compacting routine to compact earth at the location to meet the target elevation. In such an implementation, the compaction routine may instruct the hydraulic distribution module 630 to adjust the tool to sweep earth to the location from the surrounding area and spread earth around the surface of the location. In an alternate implementation, the filling module 820 may fill earth in a location to an elevation above the target elevation at specific points at the location and the compacting module 830 may compact the earth at those specific points to meet the target elevation.

### VI. Additional Considerations

It is to be understood that the figures and descriptions of the present disclosure have been simplified to illustrate elements that are relevant for a clear understanding of the present disclosure, while eliminating, for the purpose of clarity, many other elements found in a typical system. Those of ordinary skill in the art may recognize that other elements and/or steps are desirable and/or required in implementing the present disclosure. However, because such elements and steps are well known in the art, and because they do not facilitate a better understanding of the present disclosure, a discussion of such elements and steps is not provided herein. The disclosure herein is directed to all such variations and modifications to such elements and methods known to those skilled in the art.

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

While particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for filling earth at a site, the method comprising:
accessing, from a computer memory communicatively coupled to an excavation vehicle (EV), an elevation map of the site, the elevation map describing a target elevation for earth at a plurality of locations within the site;
executing, with a computer communicatively coupled to the excavation vehicle, a set of instructions comprising:
retrieving earth from a first of the locations within site with a tool physically coupled to the EV;
navigating the tool to a second of the locations, the second location located a physical distance away from the first location;
positioning a leading edge of the tool above a surface of the second location;
releasing earth from the tool onto the surface of the second location; and
recording an updated elevation of earth at the second location with a sensor mounted on the EV.

2. The method of claim 1, wherein the elevation map comprises an array of coordinate locations, each coordinate location of the array associated with an elevation of earth at that location.

3. The method of claim 1, wherein earth at the first location is at a higher elevation than earth at the second location.

4. The method of claim 1, wherein positioning the tool comprises:
sending an instruction from a computer controller physically coupled to the EV to a hydraulic system of the EV to allocate hydraulic pressure to allow the tool to be moved.

5. The method of claim 1, wherein navigating the tool comprises:
sending an instruction from the computer controller physically coupled to the EV to the hydraulic system of the EV to allocate hydraulic pressure to move the EV towards the second location.

6. The method of claim 1, wherein releasing earth onto the surface of the second location further comprises one of the following:
sending an instruction from the computer controller physically coupled to the EV to the hydraulic system of the EV to allocate hydraulic pressure to open the tool; and
sending an instruction from the computer controller physically coupled to the EV to the hydraulic system of the EV to allocate hydraulic pressure to adjust the angle of the tool relative to the ground surface.

7. The method of claim 1, wherein positioning the leading edge of the tool above the surface of the second location comprises:
recording data with one or more sensors mounted on the EV;
updating a virtual representation of the site based on the recorded data, the virtual representation representing the site as a coordinate space comprising a plurality of coordinates; and
positioning the leading edge of the tool above the surface of the second location based on the updated virtual representation of the site.

8. The method of claim 7, wherein the one or more sensors comprise:
an incline sensor mounted on the tool;
a linear encoder mounted on the tool; and
a spatial sensor mounted on the tool.

9. The method of claim 1, wherein positioning the leading edge of the tool comprises:
measuring the relative position by measuring the distribution of hydraulic pressure between the drive system and the tool, the distribution determining the orientation of the tool and the position of the EV within the coordinate space of the virtual representation.

10. The method of claim 1, wherein positioning the leading edge of the tool based on the updated virtual representation comprises:
tracking the absolute position of the chassis within the coordinate space with a global positioning sensor mounted on the EV;
analyzing kinematic measurements to describe the hydraulic distribution of the EV; and
determining the position of the tool relative to the chassis.

11. The method of claim 10, wherein tracking the absolute position comprises measuring a quantity with a measurement sensor mounted on the EV and converting the measurement to an absolute position of the tool with a lookup table stored in the computer memory.

12. The method of claim 11, wherein tracking the absolute position comprises measuring a quantity with the measurement sensor mounted on the EV and converting the measurement to an absolute position using forward kinematics.

13. The method of claim 1, wherein, when executed, the set of instructions cause the EV to:
generate, with the computer communicatively coupled to the EV, a comparison between the set of coordinates of the target elevation of the digital file and the updated elevation of the elevation map.

14. The method of claim 1, further comprising:
responsive to the comparison indicating a threshold difference between the current elevation and target elevation,
navigating, by the drive system, from the second location to the first location;
retrieving additional earth from the first location; and
navigating, by the drive system, from the first location to the second location.

15. The method of claim 1, further comprising:
responsive to the comparison indicating a threshold difference between the current elevation and target elevation,
navigating, by the drive system, from the second location to the dump pile;
releasing earth from the tool onto the surface of the dump pile; and
navigating, by the drive system, from the dump pile to the first location.

16. The method of claim 1, further comprising:
responsive to the comparison indicating a threshold difference between the current elevation and target elevation,
identifying a location in proximity to the second location at current elevations below the target elevation;
navigating, by the drive system, from the second location to the identified location;
releasing earth from the tool onto the surface of the identified location; and
navigating, by the drive system, from the identified location to the first location.

17. The method of claim 1, wherein while the tool is moved over the surface of the second location, the set of instructions further comprise:
recording, by the spatial sensor mounted to the EV, the volume of earth released from the tool onto the surface of the second location without interrupting the movement of the tool along the surface of the second location.

18. The method of claim 17, wherein while the tool is moved over the surface of the second location, the set of instructions further comprise:
measuring, by the spatial sensor mounted to the EV, a tool fill level describing the volume of earth within the tool; and
responsive to measuring an amount of earth in the tool to be below a threshold amount, sending an instruction from the computer controller physically coupled to the EV to the hydraulic system of the EV to halt the movement of the tool over the surface of the second location.

19. The method of claim 17, wherein measuring the tool fill level further comprises:
sending an instruction from the computer controller physically coupled to the EV to the hydraulic system of the EV to allocate hydraulic pressure to position the leading edge of the tool such that earth within the tool is within a field of view of the sensor mounted to the EV.

20. The method of claim 1, wherein positioning the leading edge of the tool above the surface of the second location further comprises:
positioning the leading edge of the tool at a position in contact with the surface of the second location, contact with the surface of the second location detected by the measurement sensor mounted to the EV;
positioning the leading edge of the tool at a position above the surface of the second location; and
oscillating the leading edge of the tool between the position in contact with the surface and the second position above the surface to achieve a target compaction for earth at the second location, the target compaction representing a predetermined change in volume associated with earth at the second location.

21. The method of claim 21 wherein oscillating the leading edge of the tool comprises:
sending an instruction from the computer controller physically coupled to the EV to the hydraulic system of the EV to allocate hydraulic pressure to adjust the position of the tool relative to the surface.

22. The method of claim 1, wherein positioning the leading edge of the tool above the surface of the second location further comprises:
positioning the leading edge of the tool at the position in contact with the surface of the second location; and
navigating the tool over the surface of the second location at a constant speed.

23. The method of claim 22, further comprising:
determining the distribution of hydraulic pressure to maintain the speed of the tool over the surface of the second location based on one or more of the following:
a weight measurement for earth in the tool; and
a representation of a geometry of the leading edge profile of the tool.

24. The method of claim 1, wherein, when executed, the set of instructions causes the EV to measure the compaction level of earth at the second location by:
releasing, from the EV, a compaction probe below the surface of the second location; and
measuring, by a compaction sensor mounted to the EV, a number of particles transmitted through the earth from the probe.

25. The method of claim 1, further comprising:
receiving, from the computer memory communicatively coupled to the EV, a target compaction for earth at the second location and a compaction graph relating the target compaction with a change in a volume for earth at the second location, the change in volume representing a difference between the volume of earth at the second location before positioning the tool beneath the ground surface and after navigating the tool over the surface of the second location;
measuring a current change in volume of earth at the second location using the spatial sensor mounted to the EV; and
determining a current compaction level of earth at the second location based on the target compaction of the accessed graph and the current change in volume of earth at the second location.

26. The method of claim 25, wherein determining the compaction level of earth comprises:
identifying a type of earth at the second location, the types of earth including one or more of the following:
soil,
clay, and
gravel.

27. The method of claim 25, wherein the target compaction is based on one or more earth properties, the properties comprising:
a density measurement for earth before compaction at the second location;
a density measurement for earth after compaction at the second location;
a soil cohesion measurement; and
a particle size measurement for earth within the tool.

28. The method of claim 25, further comprising:
compacting a plurality of sample of earths to a plurality of target compactions with the tool of the EV;
recording the volume of each target compaction of the plurality with the spatial sensor mounted to the EV;
determining a change in volume for each target compaction based on an initial volume measurement for each sample with the computer communicatively coupled to the EV; and
generating a compaction graph relating the plurality of target compactions to the changes in volume.

29. A non-transitory computer readable storage medium storing instructions for filling earth at a site encoded thereon that, when executed by a processor, cause the processor to perform the steps comprising:
accessing, from a computer memory communicatively coupled to an excavation vehicle (EV), an elevation map of the site, the elevation map describing a target elevation for earth at a plurality of locations within the site;
executing, with a computer communicatively coupled to the excavation vehicle, a set of instructions comprising:
retrieving earth from a first of the locations within site with a tool physically coupled to the EV;
navigating the tool to a second of the locations, the second location located a physical distance away from the first location;
positioning a leading edge of the tool above a surface of the second location;
releasing earth from the tool onto the surface of the second location; and
recording an updated elevation of earth at the second location with a sensor mounted on the EV.

30. A system comprising:
a processor; and
a non-transitory computer readable storage medium storing instructions for filling earth at a site encoded thereon that, when executed by a processor, cause the processor to perform the steps comprising:
accessing, from a computer memory communicatively coupled to an excavation vehicle (EV), an elevation map of the site, the elevation map describing a target elevation for earth at a plurality of locations within the site;
executing, with a computer communicatively coupled to the excavation vehicle, a set of instructions comprising:
retrieving earth from a first of the locations within site with a tool physically coupled to the EV;
navigating the tool to a second of the locations, the second location located a physical distance away from the first location;
positioning a leading edge of the tool above a surface of the second location;
releasing earth from the tool onto the surface of the second location; and
recording an updated elevation of earth at the second location with a sensor mounted on the EV.
